(19) United States
(12) Patent Application Publication
(10) Pub. No.: US 2020/0250709 A1
(43) Pub. Date: Aug. 6, 2020

(54) CONVERSION AND DOCUMENT MANAGEMENT SYSTEM

(71) Applicant: Mimiran LLC, Austin, TX (US)

(72) Inventor: Reuben Swartz, Austin, TX (US)

(21) Appl. No.: 16/264,936

(22) Filed: Feb. 1, 2019

(51) Int. Cl. G06Q 30/02

(52) U.S. Cl. CPC G06Q 30/0273; G06Q 30/0249; G06Q 30/0277; G06Q 30/0246

(57) ABSTRACT

This system provides services companies and other firms that have conversations with prospective new customers or clients with capabilities to evaluate online messaging, content, and/or advertising based on individual value of each new customer or client to the company or firm. The system achieves this by providing an online application environment or platform for generating marketing and sales content together with online user or device tracking and document management capabilities.

### CROSS-REFERENCE TO RELATED APPLICATION(S)

This application claims priority to U.S. Provisional Application No. 62/624,878, filed on Feb. 1, 2018 and entitled “Method to Improve Conversions in a Unified Combination of Online and Offline Commerce,” the entirety of which is incorporated herein by reference.

### BACKGROUND

Tracking user and customer data as a customer visits various online sites and platforms is becoming more and more common. Typically, companies desire to understand traffic patterns associated with how a client or customer arrived at the company's site and how the customer navigates through the site prior to a purchase event. For sales in which the entire cycle from advertisement to purchase takes place in an online fashion, the systems may track the entire conversion process or path. Unfortunately, if any step of the cycle is performed off line, such as via a phone call, email, or in person meeting, the data required to accurately connect a conversion with a particular online user is lost. In these types of situations, the industry typically tracks views or impressions rather than conversion data. However, neither views nor impressions are ideal and can often result in misleading conclusions being drawn and large sums of money and computer resources being wasted.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates an example system for generating conversion data according to some implementations.

FIG. 2 illustrates another example system for generating conversion data according to some implementations.

FIG. 3 illustrates another example system for generating conversion data according to some implementations.

FIG. 4 illustrates another example system for generating conversion data according to some implementations.

FIG. 5 is another example pictorial diagram showing associations between online content and an administrator system according to some implementations.

FIG. 6 is an example flow diagram showing an illustrative process for generating conversion data according to some implementations.

FIG. 7 is another example flow diagram showing an illustrative process for generating conversion data according to some implementations.

FIG. 8 is another example flow diagram showing an illustrative process for generating conversion data according to some implementations.

FIG. 9 is another example flow diagram showing an illustrative process generating conversion data according to some implementations.

FIG. 10 illustrates example components of one or more servers associated with an administrator system according to some implementations.

### DETAILED DESCRIPTION

This disclosure includes techniques and implementations for an administrative system for tracking conversion data related to services and goods that often have offline steps or components to a sales cycle. For instance, the system discussed herein, may be configured to collect and correlate client's or customer's online activities (e.g., advertisement views and clicks, website visits, online content consumption, etc.) with typical offline activities (e.g., phone calls, meetings, contract offers and acceptance, etc.). In this manner, the system is able to generate conversion data or metrics (such as actual value or dollar amounts associated with sales generated in part based on online advertisement spend). Thus, the company or seller may be better informed with regards to actual return on investments and actual reception of online messaging than with conventional systems.

For example, a service company may run a number of online messages or advertising campaigns, such as via Facebook®, Google®, Twitter®, or other social media platforms. In this example, if the service company runs two advertisements, A and B, the two advertisements A and B will have different levels of success. Under a conventional system, if the company spends the same amount (e.g., $10,000) and the advertising platform displays each advertisement the same number of times (e.g., 5,000), the company may receive the results shown in Table 1 below:

TABLE 1

| | Ad A | Ad B |
|---|---|---|
| Ad Spend | $10,000 | $10,000 |
| Display Count | 5,000 | 5,000 |
| Clicks | 200 | 250 |
| Click through Rate | 4% | 5% |
| Newsletter Signups | 20 | 50 |
| Signup Rate per Click | 10% | 20% |
| $ per Signup | $500 | $200 |

In this example, it appears that advertisement B outperformed advertisement A. For instance, advertisements B earned 250 clicks, 50 more than advertisement A, 5% click through rate over the 4% of advertisement A. advertisement B also earned 30 more signups than advertisements A. The company may then conclude that the cost per signup is $200 per new customer or client running advertisement B opposed to $500 per new customer or client running advertisement A. The end result is that the service company or the advertising platform on behalf of the company, redirects the marketing budget into advertisement B and may stop spending on advertisement A, as illustrated below in Table 2.

TABLE 2

| | Ad A | Ad B |
|---|---|---|
| Spend | $0 | $20000 |
| Displays | 0 | 10000 |
| Clicks | 0 | 500 |
| Click through Rate | 0% | 5% |
| Newsletter Signups | 0 | 100 |
| Signup Rate per Click | 0% | 20% |
| $ per Signup | — | $200 |

However, in the example of Tables 1 and 2 above, the conventional system failed to account for the value of each individual client or customer. In other words, the conventional system values each client as having the same value to the service company and favors the advertisements that return the greatest number of views, clicks, or new customers. Unfortunately, with many service style companies, most of the company's revenue may be derived from a single or handful of reoccurring or large product customers or clients. Thus, the conventional system fails to capture data associated with the value of each individual client, process and/or analyze the data associated with the value of each individual client, or perform any operations based at least in part on the data associated with the value of each individual client.

Table 3 below applies the example above but to the system discussed herein, that is configured to monitor and analyze individual value of each new and reoccurring client per advertisement. For instance, assume that the example of Table 3 has the same two advertisements, A and B, with the same amount spent, same number of displays, same click through rate, and same number of signups. In this second example however, the system has the additional information related to the number of conversions and the value of each conversion. To keep the example simple, for Table 3 below, assume that the service company has project minimum of $100,000 (e.g., the service company is a high-end consultancy, home remodeling company, or legal litigation firm). Also assume that half of the signups associated with advertisement A result in a conversion, while none of the signups associated with advertisement B result in a conversion, as illustrated below.

TABLE 3

| | Ad A | Ad B |
|---|---|---|
| Spend | $10000 | $10000 |
| Displays | 5000 | 5000 |
| Clicks | 200 | 250 |
| Click through Rate | 4% | 5% |
| Opt-in Signups | 20 | 50 |
| Signup Rate per Click | 10% | 20% |
| Conversion Rate per Opt-in | 50% | 0% |
| $ Per Deal | $100,000 | — |
| Total Revenue | $1,000,000 | $0 |
| Revenue $/Ad $ | $100 | — |

As a result, Table 3 illustrates that the actual value of advertisement B to the service company is $0.00 (or a loss of $10,000 with the costs associated with the advertisement), while the actual value of advertisement A is $1,000,000 (or a gain of $990,000 with the costs associated with the advertisement). Various rationales may explain the discrepancy between signups and conversion value. For instance, the advertisement B may be displayed to the wrong demographic (e.g., apartment renters in the case of a remodeling company) or the content of advertisement B may be misleading (e.g., resulted in the potential customer in a request for more information but the additional information informed the potential customer that the services were of no real interest).

In this example, if the service company utilized the conventional systems, discussed above with respect to Tables 1 and 2, which valued signups over everything else, the conventional platform or the service company would have discontinued advertisement A and increased spending on advertisement B costing the service company a loss and possibly financial strain or bankruptcy. However, if the service company was utilizing the platform or system discussed herein, the service company would instead divert spending from advertisement B to advertisement A, as advertisement A generated $1,000,000 in new revenue. It should be understood, that the system discussed herein can apply the same analytical capabilities to other forms of online lead generation beyond advertisements, including “content marketing”, “SEO” (“Search Engine Optimization”), and online referral partners and IPO.

In some implementations, the administrator system discussed herein, may be configured to track a potential clients' online activity. For example, a third-party social media or advertising system may run an advertisement to drive potential customers to particular online content, such as on a service provider's website. The administrator system may then track the online activities of the client and/or the client's device using various techniques, such as activity logging on the administrator system based on client requests for content to the system, cookies or pixel tacking. Thus, once the potential client accesses the content, the administrator system is able to track and correlate online activities, such as number of visits by the potential customer to the service provider's website.

The administrator system may also be configured to transmit impression data to the third-party social media or advertising system. For instance, the service company may utilize a social media platform, such as Google®, Facebook®, or Instagram®, etc., to provide targeted online content to their users. In exchange, these platforms may allow the administrator system to request or pull the impression data associated with the service company targeted advertisements. In some cases, the impression data may include number of views, number of clicks, and the identity of the user's that viewed/clicked an advertisement, etc.

The administrator system may also be configured to process offer/acceptance transitions between the service provider and the customers or clients. For instance, in the case of an attorney, the potential client eventually has a meeting with the attorney. The project is discussed for scope and complexity. The offer details, such as deposit, retainer, hourly rate, and scope of work, may then be agreed upon. The offer details and the new client details (e.g., name, address, entity type, etc.) may then be entered or provided by the attorney or service provider into the administrator system. The administrator system may then generate an offer based on the offer details and the new client details and provide the offer as a contract, statement of work, invoice, or other written document to the new client. The new client may then execute or otherwise approve the offer via the administrator system. The administrator system may also track, execute, or supply any change orders or additional projects added by the service provider or new client.

As the administrator system has the identity of the potential customers whom viewed and/or clicked on an advertisement placed via the third-party social media or advertising system, the identity of the potential customers who viewed the online content of the service provider, and the details related to each conversion (e.g., via the offer/acceptance system), the administrator system is able to identify which conversion are associated with which advertisement and which third-party social media, online content, referral link, advertising system, or other online mechanism. The administrator system also has the dollar value of each conversion as part of the offer/acceptance system. Thus, even more detail than that provided in Table 3 above may be generated as part of the conversion data and utilized by the administrator system and/or the service provider to improve the return on investment.

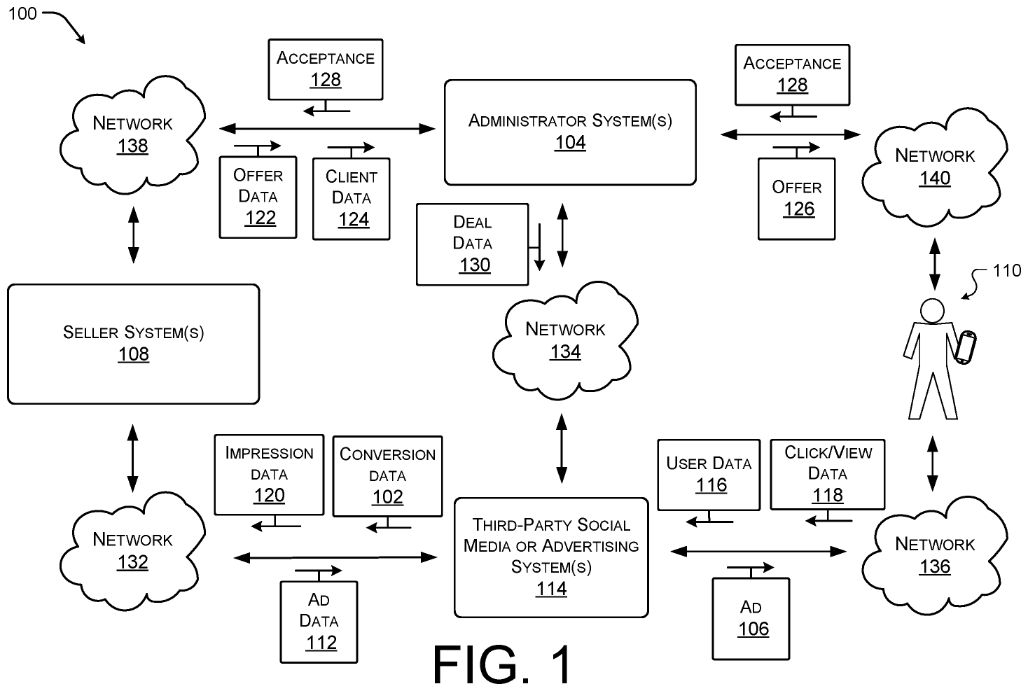

FIG. 1 illustrates an example system 100 for generating conversion data 102 according to some implementations. In the illustrated example, a seller or company may provide a service or goods (such as custom goods) that are not available for purchase via an online platform or site. For example, many custom projects require individualized pricing, quotes, and discussions with an expert prior to making a purchase. The administrator system 104, discussed herein, is configured to generate the conversion data 102 associated with each online advertisement 106, such that the seller or company is able to more accurate determine a return on investment associated with the placement, usage, and advertisements 106 associated with development of online content.

In the illustrated example, a seller may utilize a seller system 108 to provide online content to users, generally indicated by 110, and to provide advertisement data 112 to a third-party social media or advertising system 114. The third-party social media or advertising system 114 may utilize the advertisement data 112 to generate an advertisement 106 that may be provided to a first set of users 110. In some cases, the third-party social media or advertising system 114 may monitor the user and/or user device that the advertisement 106 is displayed on as well as a second set of user's or user devices that click on or access, content associated with the advertisement 106.

For instance, the third-party social media or advertising system 114 may cause the advertisement 106 to be displayed to 1,000,000 users via corresponding user devices. 100 of the users may select to view additional content associated with the advertisement 106 (e.g., a click or view). These 100 users may then be displayed online content associated with a good or service provided by the seller (e.g., redirected to a page of a website hosted by the seller system 108).

The third-party social media or advertising system 114 may then collect or store the user data 116 and/or click/view data 118 (e.g., the number of times the advertisement 106 is presented on a user device and the number of redirects preformed) corresponding to the advertisement 106. In some cases, the third-party social media or advertising system 114 may convert the user data 116 and/or click/view data 118 as well as other data associated with the advertisement 106 into impression data 120 which may be provided back to the seller system 108.

In some case, a third set of users, such as a subset of the second set of users that viewed the online content, may contract the seller or a company representative outside of the online environment. For instance, the individuals of the third set of users may call, video conference, have an in-person discussion (e.g., meet for coffee), etc. with the seller or the company representative.

Some additional subset of the third set of users (e.g., a fourth set of users or clients) may agree or purchase goods/services from the seller or a company representative. In these cases, the seller may utilize the seller system 108 to generate offer data 122 (e.g., data associated with the particular project, goods, or service being performed) and/or client data 124 (e.g., the individual or entity purchasing the particular project, goods, or services). The seller system 108 may then provide the offer data 122 and the client data 124 to the administrator system 104. The administrator system 104 may then generate an offer 126 from the offer data 122 and/or the client data 124. The offer 126 may then be provided to the particular individual or client. Thus, it should be understood, that each individual of the fourth set of users may receive a customized offer 126 from the administrator system 104.

The particular client 110 may send an acceptance 128, back to the administrator system 104 and/or to the seller system 108. In some cases, multiple offers 126 may be provided or negotiated between the seller and the client 110 via the administrator system 104 prior to receiving the acceptance 128.

In some implementations, the administrator system 104 may also provide for execution of any agreements or documentation associated with the offer 126. For example, the administrator system 104 may allow both the seller system 108 and the client 110 to access an agreement associated with the offer 126 for execution via electronic signatures.

As part of providing and receiving offers 126 and acceptances 128 between the seller system 104 and the client 110, the administrator system 108 may extract or collect deal data 130 associated with each acceptance 128. For example, the deal data 130 may include some or all of the client data 124, the offer data 122, as well as data associated with the total monetary value of the offer 126, length of client/seller relationship (e.g., a new client or reoccurring client), period of time between first impression of the advertisement 106, first view of the advertisement 106, first access of online content hosted by the seller system 104, and/or receiving the offer data 122 or client data 124 from the seller system 108 and the acceptance 128, number of times number online content has been viewed, location of viewer(s) based on geographic translation of viewers IP (Internet Protocol) address, which options have been selected by the buyer or client in the event the seller offers more than one option in the offer, quantities selected by the buyer in the case the seller offers the buyer a choice of quantities for some components of the offer, of acceptances/projects per a given period, lifetime number of acceptances/projects, average size or value of acceptances/projects per client, average number of acceptances/projects per client, average size or value of acceptances/projects across clients, average number of acceptances/projects across clients, among others.

In some implementations, the administrator system 104 may also process the payment associated with the acceptance 126. For example, the administrator system 104 may include an online payment processing module. In these case, the administrator system 104 may also be able to include a lifetime or per deal collection data as part of the deal data 130.

In the illustrated example, the deal data 130 once collected, generated, and/or aggregated may then be provided by the administrator system 104 to the third-party social media or advertising system 114. The third-party social media or advertising system 114 may then utilize then combine the deal data 130 with the impression data 120 (e.g., data derived from user data 116 and/or click/view data 118) to generate conversion data 102. The conversion data 102 is then provided to the seller system 108 for the seller to analyze and, thereby, adjust the advertisement data 112, such that new advertisements 106 may be provided to the users 110.

In the illustrated example, data is shown as communicated between the systems 104, 108, 114, and the devices of the users 110 via various networks, such as networks 134-140. However, it should be understood that in some situations, various ones of the networks 134-140 may be the same, such as the Internet®. Additionally, while the data is shown as being sent/received by the various systems 104, 108, 114, and the devices of the users 110, it should be understood, that in some instance, the data may be stored and accessed by the 104, 108, 114, and the devices of the users 110, such as part of cloud-based computing services.

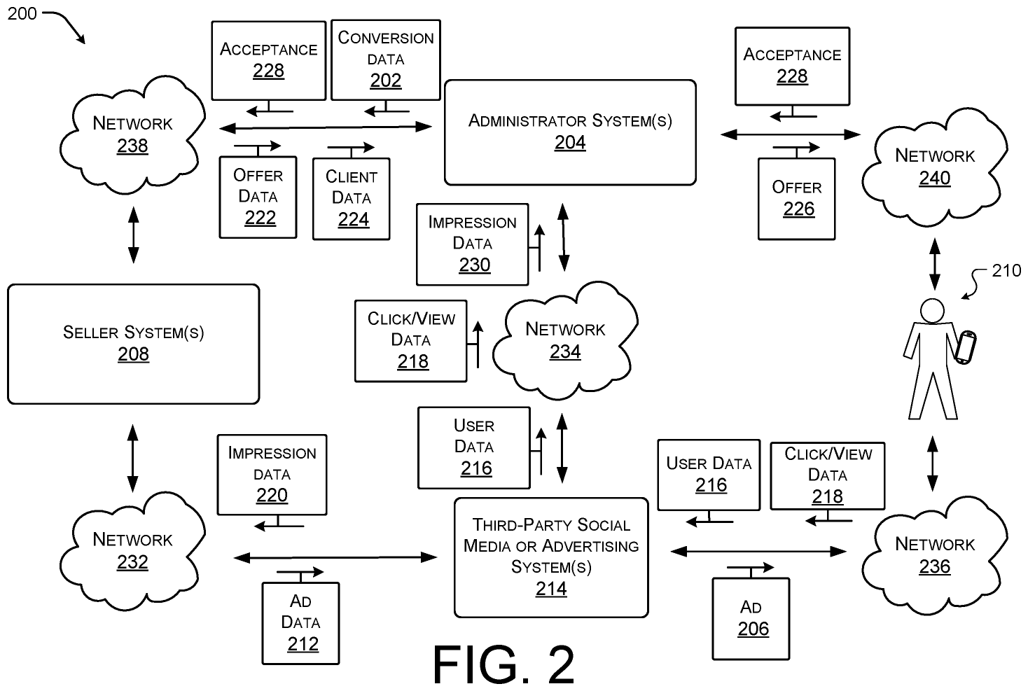

FIG. 2 illustrates another example system 200 for generating conversion data 202 according to some implementations. Similar to the implementation of system 100 of FIG. 1, in the current example, the seller system 208 may be configured to generate advertisement data 212 for a third-party social media or advertising system 214. The third-party social media or advertising system 214 may utilize the advertisement data 212 to generate and cause advertisements 206 to be viewed by a first set of users 210, while collecting user data 216 and click/view data 218 associated with the advertisements 206.

Again, some subset of the first set of users (e.g., the second set of users) may consume content associated with the advertisements 206. A subset of the second set of users (e.g., the third set of users) may contact the seller and a subset of the third set of users (e.g., the fourth set of users) may become clients or particular project, goods, or services from the sellers.

The administrator system 204 again facilitates the offer 226 and acceptance 228 based on the offer data 222 and/or the client data 224 received from the seller system 208. In some cases, the administrator system 204 may store the offer data 222, such as when the seller has standard offers. The administrator system 204 may then maintain or generate a set of ready to send offers 226 based on the standard offer data 222. In these cases, the administrator system 204 may then receive the client data 224 and generate the particular offer 226 for the particular client using the ready to send offers 226 and the client data 224. In some cases, the administrator system 204 may receive the client data 224 and generate a custom offer based on the client data 224 on behalf of the seller. For instance, the administrator system 204 may store data associated with historical offers, rejected offers, accepted offers, third-party offer data (e.g., competitor pricing, competitor services/goods, etc.), client's physical location, client's sophistication, client's entity type and/or size, client's industry, size of the offer (e.g., hours required, period of time till completion, dollar value, reputational value, etc.), likelihood of renewal, likelihood of complication, current project/workload (e.g., availability of staff time to perform the activities, hard costs associated with the goods/service, etc.), size of seller's current client base, among others.

In this example, unlike the example of FIG. 1, once the acceptance 228 is received by the administrator system 204, the administrator system 204 generates the conversion data 202. In this example, the third-party social media or advertising system 214 may provide or send the impression data 230, click/view data 218, and/or the user data 216 associated with the advertisement 206 to the administrator system 204. In other cases, the administrator system 204 may query the impression data 230, click/view data 218, and/or the user data 216 associated with the advertisement 206 from the third-party social media or advertising system 214 or the 204 may query the impression data 230, click/view data 218, and/or the user data 216 associated with the advertisement 206 may be accessible to the administrator system 204 via a cloud-based service.

The administrator system 204 may then correlate the client data 224 associated with individual offers 226 with the user data 216 to associate each particular offer 226 with a particular advertisement 206. In this manner, the administrator system 204 may generate conversion data 202 including the dollar value to the seller for each particular advertisement 206. In one implementation, the administrator system 204 may correlate the client with the particular advertisement 206 based on a security token required to access the content or offer, which is unique to the client, and shared directly with the client via email or other means, device identifies, internet protocol (IP) address, email address, and/or among others. For example, the impression data 230 may include a device identifier or IP address associated with each user that was presented the advertisement 206 and/or each user that accessed or clicked on the advertisement 206. The administrator system 204 may also have the client's device identifier, IP address, email, or other identifier as part of the offer/acceptance interchange. Thus, the administrator system 204 may associate the advertisement 206 with a client 210 based at least in part on overlapping of one or more of the client's device identifier, the IP address, the email, or other identifiers.

In the illustrated example, data is shown as communicated between the systems 204, 208, 214, and the devices of the users 210 via various networks, such as networks 234-240. However, it should be understood that in some situations, various ones of the networks 234-240 may be the same, such as the Internet®. Additionally, while the data is shown as being sent/received by the various systems 204, 208, 214, and the devices of the users 210, it should be understood, that in some instance, the data may be stored and accessed by the 204, 208, 214, and the devices of the users 210, such as part of cloud-based computing services.

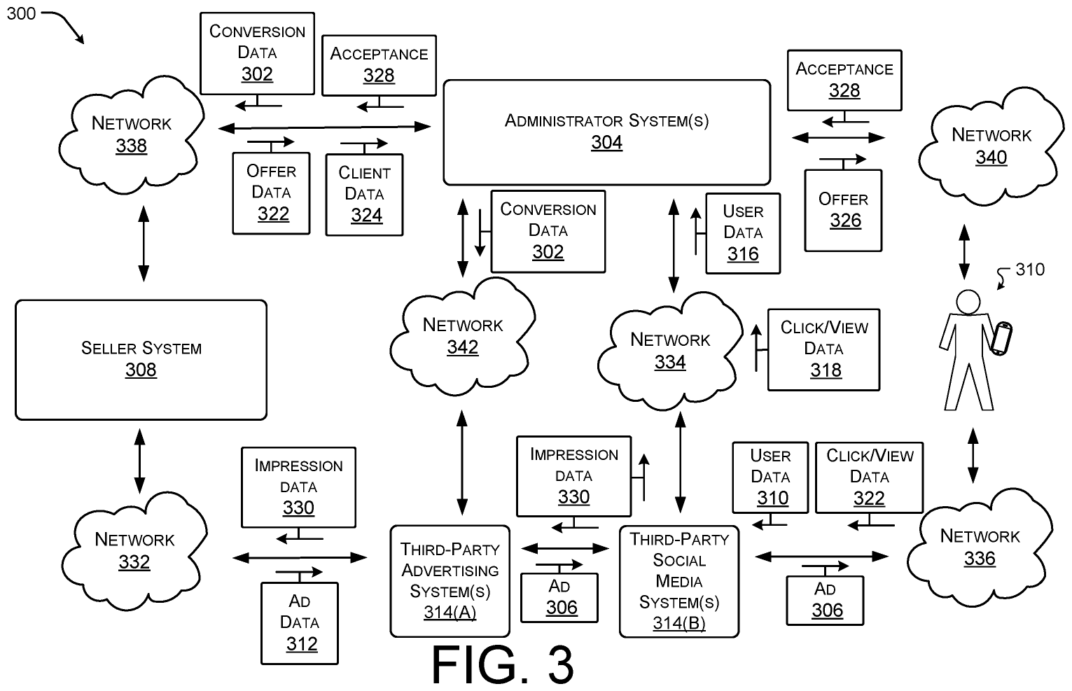

FIG. 3 illustrates another example system 300 for generating conversion data 302 according to some implementations. In some cases, the third-party advertising system 314(A) may be distinct from the third-party social media system 314(B). For instance, the third-party advertising system 314(A) may be a marketing firm that develops online content (such as the advertisement 306 from the advertisement data 312) for distribution to the users 310 via the third-party social media system 314(B).

In this example, the administrator system 304 may receive the offer data 322 and the client data 324 associated with each offer 326 from the seller system 308 as discussed above. The administrator system 304 may also receive the acceptance 328 from the new client or user 310. In this example, the administrator system 304 also receives the user data 316, click/view data 318, and/or impression data 330 from the third-party social media system 314(B). As discussed above, the administrator system 304 may utilize the offer data 322, the client data 324, the user data 316, click/view data 318, and/or impression data 330, among other data to generate the conversion data 302 including a value (such as a monetary value) to the seller of the advertisement 306. In some instance, the administrator system 304 may provide the conversion data 302 to either or both of the seller system 308 and/or the third-party advertising system 314(A).

In the illustrated example, data is shown as communicated between the systems 304, 308, 314, and the devices of the users 310 via various networks, such as networks 334-342. However, it should be understood that in some situations, various ones of the networks 334-342 may be the same, such as the Internet®. Additionally, while the data is shown as being sent/received by the various systems 304, 208, 314, and the devices of the users 310, it should be understood, that in some instance, the data may be stored and accessed by the 304, 308, 314, and the devices of the users 310, such as part of cloud-based computing services.

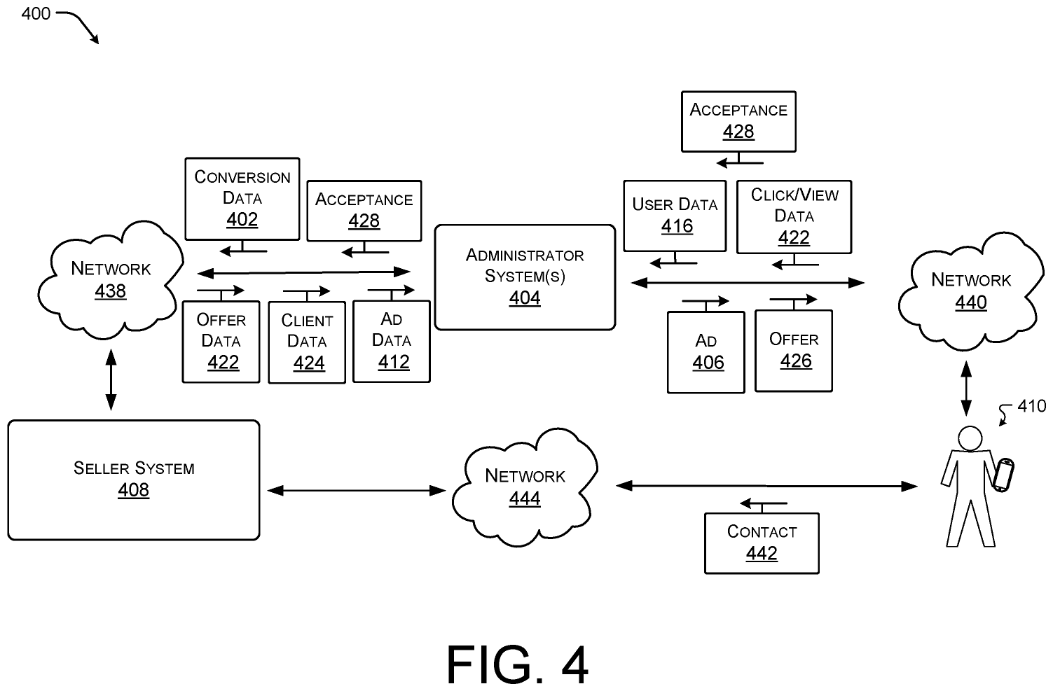

FIG. 4 illustrates another example system 400 for generating conversion data 402 according to some implementations. In some cases, the administrator system 404 may be configured to identify the potential clients and to provide the advertisements 406 directly to the first set of users 410. In this example, the administrator system 404 may present or display the advertisement on a device associated with the users 410. The administrator system 404 may then collect the user data 416 and/or the click/view data 422 or otherwise track the online activities of the user with respect to designated online content.

When the seller causes the seller system 402 to send, via the network 438, the offer data 422 and/or the client data 424 to the administrator system 404, the administrator system 404 may correlate generate the offer 426 for the specific client or user 410. When the administrator system 404 then receives the acceptance 428, via the network 440, from the specific client or user 410, the administrator system 404 may then correlate the acceptance 428, offer data 422, client data 424, and other information associated with the offer 426 with the advertisement 406 based at least in part on the user data 416 and/or the click/view data 422.

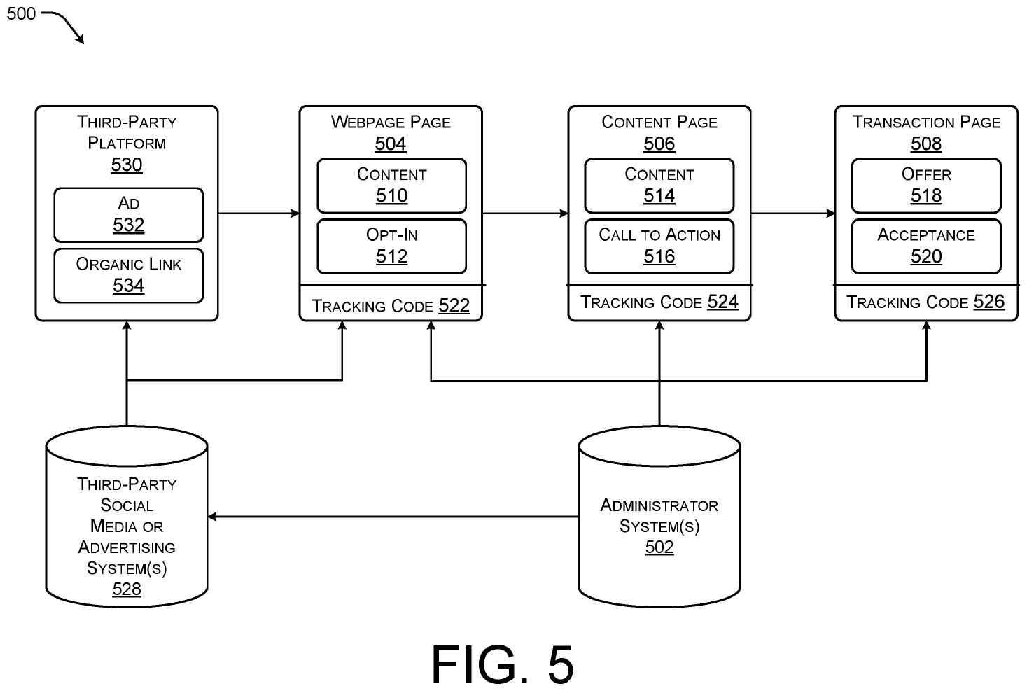

In some cases, such as the illustrated example and/or the examples of FIGS. 1-3, a user 410 may contact 442 the seller or the seller system 408 prior to the administrator system 404 receiving the offer data 422. In these cases, the contact 442 may be via a network 444. For example, the contact 442 may be a telephone call, email, request via the seller web site, etc. In some instances, the administrator system 404 may detect the contact, such as an opt-in or website visits by the user 410 to the seller's website, as discussed below with respect to FIG. 5. It should be understood, that in some cases, the administrator system 404 may host the seller's website or portions of the seller's website.

FIG. 5 is another example pictorial diagram 500 showing associations between online content and an administrator system 502 according to some implementations. In the current implementation, online content associated with a seller or company is available via one or more networks to the general public or a set of users. For example, the online content may include a webpage page 504 (such as a home page or landing page of the seller's website), at least one content page 506 (such as a checklist or other piece of content offered in exchange for an email address and/or other lead information, and a transaction page 508 (e.g., a cloud accessible document for viewing and execution, such as a proposal, quote, contract, engagement letter).

In the current example, the landing page 500 includes first content 510 and a user selectable option to opt-in 512 to receive additional content from the seller (e.g., the content page 506) and the content page 506 includes second content 514 and a call to action 516 (such as how to request an offer from the seller). The transaction page 508 includes the offer 518 (e.g., an offer generated by the administrator system 502 for the particular user) and allows for the user to execute or accept 520 the offer 518. In some cases, each page 504-508 may include a corresponding tracking code 522-526 as illustrated to allow the administrator system 502 to identify a specific user/device each time the user/device access content (e.g., content 510 and/or 514) of one or more of the pages 504-506.

In this example, a third-party social media or advertising system 528 may be employed by the seller to direct users to the landing page 504 from the third-party platform 530. For example, the third-party platform 530 may push or present advertisements 532 to user/devices accessing content on the third-party platform 530. The third-party platform 530 may also include links 534 to cause the user/device to be redirected to the landing page 504.

In one example, a user may perform an online search using the third-party social media or advertising system 522. The advertisement 532 or the organic link 534 is presented or displayed on a device associated with the user. The user may then access the advertisement 532 or the organic link 534 and the landing page 504 is presented on the display of the device. In this example, the third-party social media or advertising system 528 is able to identify the users/devices that were presented with the advertisement 532 and/or the organic link 534.

Once the user is viewing the landing page 504, the tracking code 522 (such as a javascript snippet, cookie, or other mechanism) registers the user and/or the user's device to the administrator system 502. The third-party social media or advertising system 528 is then able to correlate the advertisement 532 and/or the organic link 534 with the viewing of the landing page 504 by the user. In some cases, the user may opt-in to receive additional content from the seller using the opt-in selection 512. For example, the opt-in selection 512 may start an educational process that prepares the user for a live conversation with the seller.

Eventually, the user may be presented content 514 associated with the content page 506. The administrator system 502 may then track the user/device using the tracking code 524. In some cases, the administrator system 502 may record or correlate the visit to the landing page 504 by the user with the visit to the content page 506 using the tracking codes 522 and 524. The user may also then follow the call to action 516 on the content page 506, such as to schedule a call or demonstration with the seller.

As discussed above, when the seller and the user are ready to finalize arrangements with an offer 518, such as a proposal, quote, contract etc., the administrator system 502 generates the offer 518. The offer 518 is made accessible to both the seller and user via a cloud-based service or via a network. When the user/device accesses the offer 518, the administrator system 502 is able to identify or register the device or user via the tracking code 526.

Once the user is associated with the offer 518, the administrator system 502 may either receive the impression data, including identifiers for the user/device that viewed/selected the advertisement 532 and/or the organic link 534, from the third-party social media or advertising system 528 or the administrator system 502 may provide the user data and offer data to the third-party social media or advertising system 528. If the administrator system 502 receives the impression data from the third-party social media or advertising system 528, then the administrator system 502 may generate the conversion data from the offer 518 and the impression data.

In some implementations, the offer 518 may be negotiable between the seller and the user. In these cases, the administrator system 502 may allow both the user and the administrator system 502 to update or alter the offer 520 one or more times prior to receiving an acceptance 520 (or execution of the offer 518). In some implementations, the administrator system 502 may track each iteration of the offer 518 and utilize the iteration data to alter future offers or template offers and/or when generating future offers. For example, if a particular starting offer is always negotiated down by a certain percentage, the administrator system 502 may start the offer at an amount increased based on the certain percentage and/or lower the initial offer by the certain percentage to avoid the negation altogether.

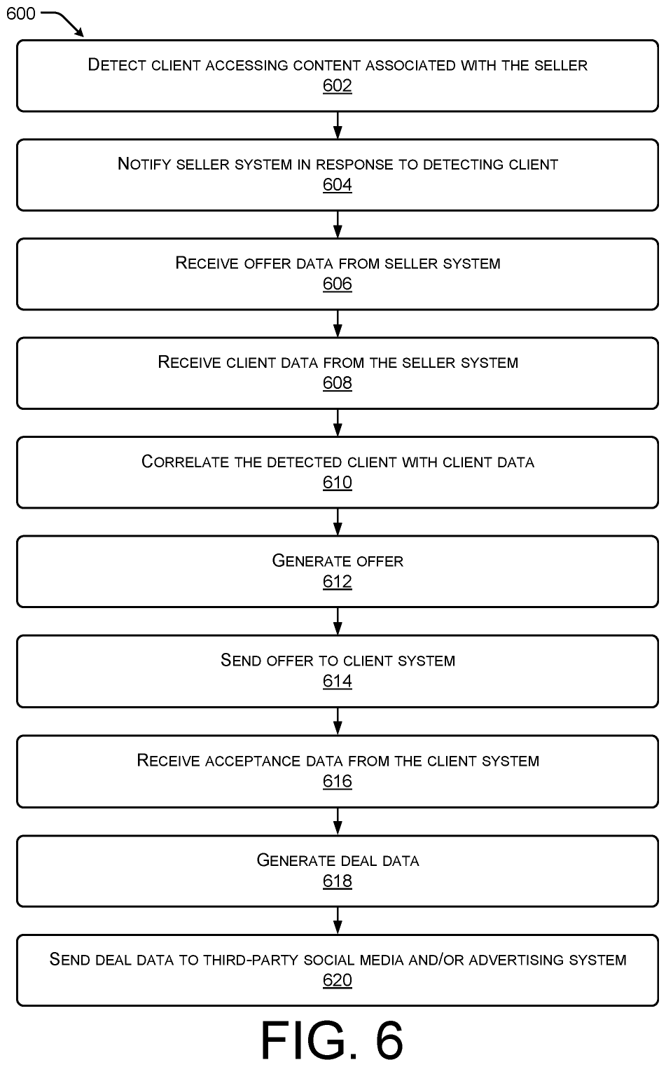

FIGS. 6-9 are flow diagrams illustrating example processes associated with generating conversion data associated with online content according to some implementations. The processes are illustrated as a collection of blocks in a logical flow diagram, which represent a sequence of operations, some or all of which can be implemented in hardware, software or a combination thereof. In the context of software, the blocks represent computer-executable instructions stored on one or more computer-readable media that, which when executed by one or more processors, perform the recited operations. Generally, computer-executable instructions include routines, programs, objects, components, encryption, deciphering, compressing, recording, data structures and the like that perform particular functions or implement particular abstract data types.

The order in which the operations are described should not be construed as a limitation. Any number of the described blocks can be combined in any order and/or in parallel to implement the process, or alternative processes, and not all of the blocks need be executed. For discussion purposes, the processes herein are described with reference to the frameworks, architectures and environments described in the examples herein, although the processes may be implemented in a wide variety of other frameworks, architectures, or environments.

In the current example, the webpage 504, the content page 506, and the transaction page 508 are hosted by the seller system or a third-party system. However, in some examples, the webpage 504, the content page 506, and the transaction page 508 or some portion of the content of the webpage 504, the content page 506, and the transaction page 508 (such as opt-in 512, content 514, call to action 516, offer 518, and/or acceptance 520) may be created and/or hosted by the administrator system 502.

FIG. 6 is an example flow diagram showing an illustrative process 600 for generating conversion data according to some implementations. As discussed above, many companies or sellers that provide goods and/or services that require an offline step or process during the sales cycle are conventionally left with inaccurate or misleading data when making decisions related to online marketing.

At 602, the administrator system may notify the seller system with respect to detecting the client accessing the content associated with the seller. For example, the administrator system may provide to the seller system a list of the identity of each user that visited the sellers website.

At 604, the administrator system may detect or identify a client or client activities while accessing web content associated with the seller. For example, the seller may have selected to opt-in to receive content associated with the services of the seller or the administrator system may have detected the client via a tracking code as the client viewed seller content either hosted by the administrator system or a third-party system.

At 606, the administrator system may receive offer data from a seller system. For example, the offer data may include details related to an offer for a particular new client (e.g., purchase or contract price, goods/services, disclaimers, warranties, scope of work, resources, deposit, retainers, deferral of fees, hourly rate, etc.), or for an existing client or customer, selection of an offer template (e.g., selection of an offer that is often used with new clients), as well as other data.

At 608, the administrator system may receive client data from a seller system. The client data may include information related to the client, such as name, entity type, address, contract information, point of contact, among others.

At 610, the administrator system may correlate the detected client with the client data received from the seller system. For example, the administrator system may identity the detected client within the client data based on an identify associated with a client device, security token generated by the administrator system, IP address, browser access, or other methods.

At 612, the administrator system may generate the offer. For example, the administrator system may generate the offer based at least in part on the offer data and/or the client data. In some cases, the administrator system may configure the signature locations, legal terms, scope of work, and purchase price based on the offer data and/or the client data. In other cases, the administrator system may also generate the offer using historical offers or template offers. In some cases, the template offers may be updated by the administrator system following receiving an acceptance of each new or current offer.

At 614, the administrator system may send the offer to a client system. For example, the administrator system may provide the offer via electronic communication or networks, such as email. In other cases, the administrator system may send a link to allow the client to access the offer. In these cases, the administrator system may maintain the offer at a cloud or network accessible location.

At 616, the administrator system may receive acceptance data from the client system. For example, the administrator system may detect or receive an electronic signature on the offer, payment for the offer, a deposit associated with the offer, or other form of acceptance.

At 618, the administrator system may generate deal data. For example, the administrator system may confirm or track the identity of the client and/or the client system when the client system is used to view and/or accept the offer. The administrator system may then couple the identity information with one or more of the details of the offer to generate the deal data. The deal data may include the identity information as well as a monetary value of the offer, project location(s), a deposit amount, client data (e.g., size, type, etc.), type of work, number of reoccurring deals or offers, deal date(s), selected options, quantities of items or services purchased, or other deal data.

At 620, the administrator system may then send the deal data to the third-party social media and/or advertising system. In the illustrated process 600, the third-party social media and/or advertising system may then correlate impression data of an online advertisement with the deal data to generate conversion data that may track an actual value of an online advertisement to the seller.

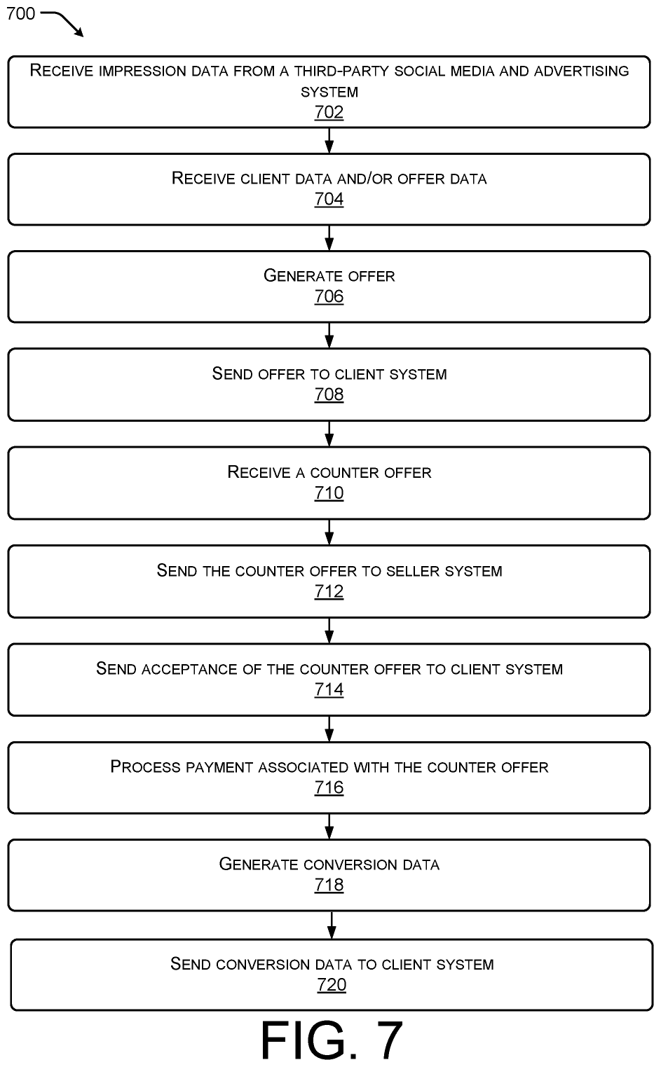

FIG. 7 is another example flow diagram showing an illustrative process 700 for generating conversion data according to some implementations. In the example illustrated with respect to FIG. 6, the third-party social media and/or advertising system may generate the conversion data. However, in the current example, the administrator system may generate and send the conversion data to the seller system.

At 702, the administrator system may receive impression data form a third-party social media and/or advertising system. For example, the administrator system may access or request the impression data on behalf of a seller from the third-party social media and/or advertising system and the third-party social media and/or advertising system may then return the requested impression data associated with one or more online advertisement of the seller. The impression data may include the identity of the individuals and/or devices (e.g., IP address or device ID) that viewed the online advertisement and/or the identity of the individuals and/or devices that clicked on the online advertisement, geographic location, or other demographic information gathered or maintained by the third-party system.

At 704, the administrator system may receive client data and/or offer data from a seller system. For example, the offer data may include details related to an offer for a particular new client (e.g., purchase or contract price, goods/services, disclaimers, warranties, scope of work, resources, deposit, retainers, deferral of fees, hourly rate, etc.), selection of an offer template (e.g., selection of an offer that is often used with new clients or existing clients), as well as other data. The client data may include information related to the client, such as name, entity type, address, contract information, point of contact, among others.

At 706, the administrator system may generate the offer. For example, the administrator system may generate the offer based at least in part on the offer data and/or the client data. In some cases, the administrator system may configure the signature locations, legal terms, scope of work, possible options, and purchase price based on the offer data and/or the client data. In other cases, the administrator system may also generate the offer using historical offers or template offers. In some cases, the template offers may be updated by the administrator system following receiving an acceptance of each new or current offer.

At 708, the administrator system may send the offer to a client system. For example, the administrator system may provide the offer via electronic communication or networks, such as email. In other cases, the administrator system may send a link to allow the client to access the offer. In these cases, the administrator system may maintain the offer at a cloud or network accessible location.

At 710, the administrator system may receive a counter offer. For example, the counter offer may be provided by the client via as a new offer sent back to the administrator system or by editing the offer in the cloud-based or networked environment.

At 712, the administrator system may send the counter offer to the seller system, and, at 714, the administrator system may provide the acceptance of the counter offer to the client system. For example, the system may send an electronic notification that the counter offer is acceptable to the client system and/or request that the client execute the counter offer following approval by the seller. In some cases, once both parties have executed the offer or the counter offer, the administrator system may notify both parties that the executed documents are available for viewing or download.

At 716, the administrator system may process payment associated with the counter offer. For example, as part of the acceptance process the administrator system may require the client to provide an initial payment, deposit, and/or retainer which may be processed and transferred by the administrator system.

At 718, the administrator system may generate conversion data and, at 720, the administrator system may send the conversion data to the client system. For example, the administrator system may parse or detect the client within the impression data associated with one or more advertisements. In some cases, the administrator system may detect the client by matching or correlating a IP address, a device ID, an email, a user account name, etc. between the client system and a list included as part of the impression data. Thus, a client may not be associated with any advertisement, associated with a particular advertising, and/or associated with multiple advertisements.

In some cases, the conversion data may include some or all of the client data, the offer data, as well as data associated with the total monetary value of the offer, length of client/seller relationship (e.g., a new client or reoccurring client), period of time between first impression of the advertisement, first view of the advertisement, first access of online content hosted by the seller system, number of times viewing online content or offers, options selected and/or quantities of specific line items desired, and/or receiving the offer data 122 or client data from the seller system and the acceptance, number of acceptances/projects per a given period, lifetime number of acceptances/projects, average size or value of acceptances/projects per client, average number of acceptances/projects per client, average size or value of acceptances/projects across clients, average number of acceptances/projects across clients, among others.

In the case of multiple offer/acceptances, the administrator system may update the conversion data for each deal or acceptance. For instance, the conversion data may include a running tally of the monetary value of a particular advertisement, such that each new acceptance that is associated with a user that viewed or clicked on an advertisement is added to the conversion data at the time of closing. In some cases, if a client accepts a second or subsequent offer, the value of the subsequent offers may also be added to the conversion data. Thus, the conversion data may continue to be relevant to the seller for months or years after the online content or advertisement is published to a user base.

The conversion data may also include the number of repeat clients, the frequency of repeat clients, the total number of clients, the average value (e.g., monetary value) of a client, average number of visits or content view prior to acceptance, the average number of counter offers prior to acceptance, ratio of views to acceptances, ratio of clicks to acceptances, average cost per new client, overall value of the advertisement or online content (e.g., revenue minus costs), among others.

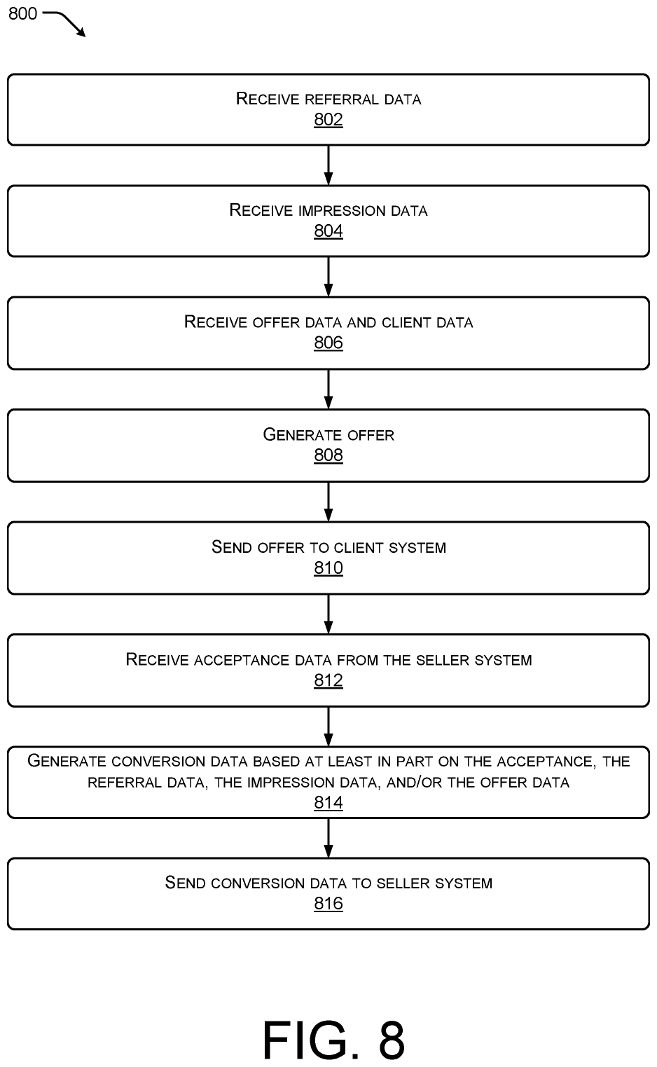

FIG. 8 is another example flow diagram showing an illustrative process 800 for generating conversion data according to some implementations. In some cases, individuals, clients, or users that have viewed an online content or received an advertisement may refer others to become clients. Conventional systems are unable to track or account for value provided by referral clients and/or sales with respect to the online content. However, the value of referral clients and/or sales is often more important than other types of metrics to a seller.

At 802, the administrator system may receive referral data. For example, the system may receive the referral data from the buyer or client, the seller system, and/or the referring user. In some cases, the referral data may include an identity of the referring user and/or the identity of the buyer or client.

At 804, the administrator system may receive impression data form a third-party social media and/or advertising system. For example, the administrator system may access or request the impression data on behalf of a seller from the third-party social media and/or advertising system and the third-party social media and/or advertising system may then return the requested impression data associated with one or more online advertisement of the seller. The impression data may include the identity of the individuals and/or devices (e.g., IP address or device ID) that viewed the online advertisement and/or the identity of the individuals and/or devices that clicked on the online advertisement.

806, the administrator system may receive offer data and/or client data from a seller system. For example, the offer data may include details related to an offer for a particular new client (e.g., purchase or contract price, goods/services, disclaimers, warranties, scope of work, resources, deposit, retainers, deferral of fees, hourly rate, etc.), selection of an offer template (e.g., selection of an offer that is often used with new clients), as well as other data. The client data may include information related to the client, such as name, entity type, address, contract information, point of contact, among others.

At 808, the administrator system may generate the offer. For example, the administrator system may generate the offer based at least in part on the offer data and/or the client data. In some cases, the administrator system may configure the signature locations, legal terms, scope of work, and purchase price based on the offer data and/or the client data. In other cases, the administrator system may also generate the offer using historical offers or template offers. In some cases, the template offers may be updated by the administrator system following receiving an acceptance of each new or current offer.

At 810, the administrator system may send the offer to a client system. For example, the administrator system may provide the offer via electronic communication or networks, such as email. In other cases, the administrator system may send a link to allow the client to access the offer. In these cases, the administrator system may maintain the offer at a cloud or network accessible location.

At 812, the administrator system may receive acceptance data from the client system. For example, the administrator system may detect or receive an electronic signature on the offer, payment for the offer, a deposit associated with the offer, or other form of acceptance.

At 814, the administrator system may generate conversion data based at least in part on the acceptance, the referral data (such as from an affiliate partner). For example, the administrator system may parse or detect the client within the impression data associated with one or more advertisements. In some cases, the administrator system may detect the client by matching or correlating a IP address, a device ID, an email, a user account name, etc. between the client system, the identity of the referring user and a list of users included as part of the impression data. Thus, in this example, the conversion data can include monetary value to an online advertisement for the referred client and/or include metrics related to auxiliary benefits of each online advertisement, such as number of clients referred, average size of referral client, secondary view of online content, etc.

At 816, the administrator system may send the conversion data to the client system and/or make the conversion data available to the seller via the administrator system and/or seller system.

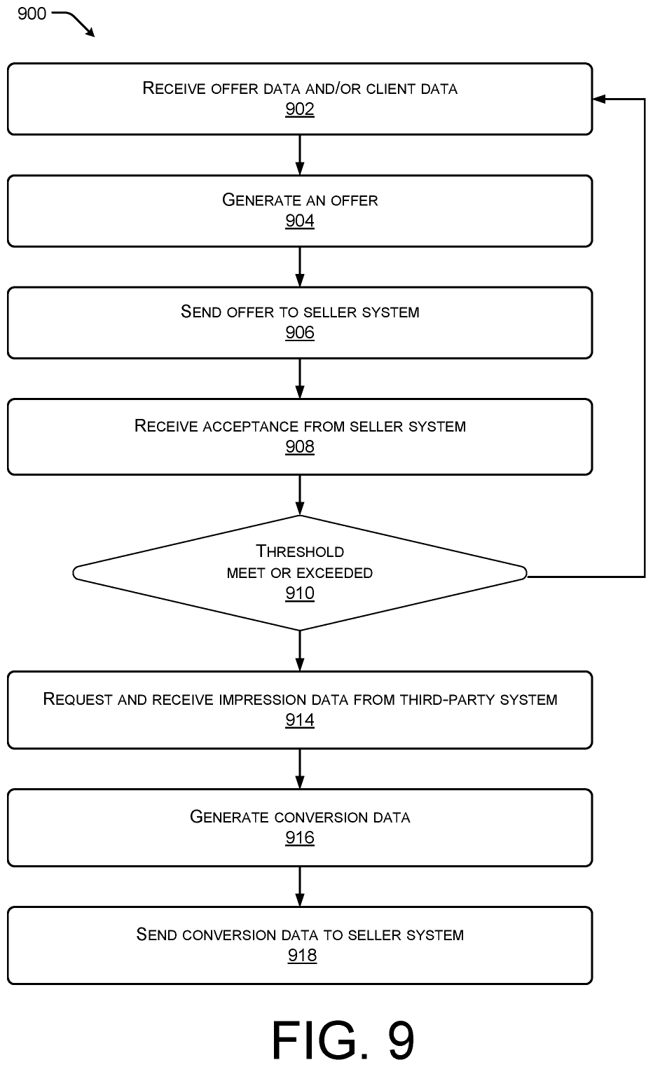

FIG. 9 is another example flow diagram showing an illustrative process 900 generating conversion data according to some implementations. In some cases, the administrator system may generate conversion data at times when various thresholds are meet or exceeded. For instance, there may be a time threshold (e.g., 6 months following the launch of the online content) or a client threshold (e.g., after every 5 acceptances).

At 902, the administrator system may receive offer data and/or client data from a seller system. For example, the offer data may include details related to an offer for a particular new client (e.g., purchase or contract price, goods/services, disclaimers, warranties, scope of work, resources, deposit, retainers, deferral of fees, hourly rate, etc.), selection of an offer template (e.g., selection of an offer that is often used with new clients), as well as other data. The client data may include information related to the client, such as name, entity type, address, contract information, point of contact, among others.

At 904, the administrator system may generate the offer. For example, the administrator system may generate the offer based at least in part on the offer data and/or the client data. In some cases, the administrator system may configure the signature locations, legal terms, scope of work, and purchase price based on the offer data and/or the client data. In other cases, the administrator system may also generate the offer using historical offers or template offers. In some cases, the template offers may be updated by the administrator system following receiving an acceptance of each new or current offer.

At 906, the administrator system may send the offer to a client system. For example, the administrator system may provide the offer via electronic communication or networks, such as email. In other cases, the administrator system may send a link to allow the client to access the offer. In these cases, the administrator system may maintain the offer at a cloud or network accessible location.

At 908, the administrator system may receive acceptance data from the client system. For example, the administrator system may detect or receive an electronic signature on the offer, payment for the offer, a deposit associated with the offer, or other form of acceptance.

At 910, the administrator system may determine if a threshold is met or exceeded. If the threshold is met or exceeded, the process 900 proceeds to 912. Otherwise, the process 900 returns to 904. In some cases, the threshold may be time based, such as a period of time elapsing. In other cases, the threshold may be event based such as a predetermined number of acceptances, a monetary threshold, a particular element being true within the offer, a particular element being true within the source of the data (such as the impression data), a particular attribute being true of the client, a predetermined number of offers, etc.

At 912, the administrator system may request and receive impression data form a third-party social media and/or advertising system. For example, the administrator system may access or request the impression data on behalf of a seller from the third-party social media and/or advertising system via an application program interface (API) call, embedded code in a webpage or generated content hosted by the system, or other mechanism. The third-party social media and/or advertising system may then return the requested impression data associated with one or more online advertisement of the seller. The impression data may include the identity of the individuals and/or devices (e.g., IP address or device ID) that viewed the online advertisement and/or the identity of the individuals and/or devices that clicked on the online advertisement.

At 914, the administrator system may receive impression data form a third-party social media and/or advertising system. For example, the administrator system may access or request the impression data on behalf of a seller from the third-party social media and/or advertising system and the third-party social media and/or advertising system may then return the requested impression data associated with one or more online advertisement of the seller. The impression data may include the identity of the individuals and/or devices (e.g., IP address or device ID) that viewed the online advertisement and/or the identity of the individuals and/or devices that clicked on the online advertisement.

916, the administrator system may generate conversion data based at least in part on the acceptance, the referral data, the impression data, and/or the offer data. For example, the administrator system may parse or detect the client within the impression data associated with one or more advertisements. In some cases, the administrator system may detect the client by matching or correlating a IP address, a device ID, an email, a user account name, etc. between the client system, the identity of the referring user and a list of users included as part of the impression data. Thus, in this example, the conversion data can include and/or credit sales or monetary value to an online advertisement for the referred client and/or include metrics related to auxiliary benefits of each online advertisement, such as number of clients referred, average size of referral client, secondary view of online content, etc.

At 918, the administrator system may send the conversion data to the client system and/or make the conversion data available to the seller via the administrator system and/or seller system.

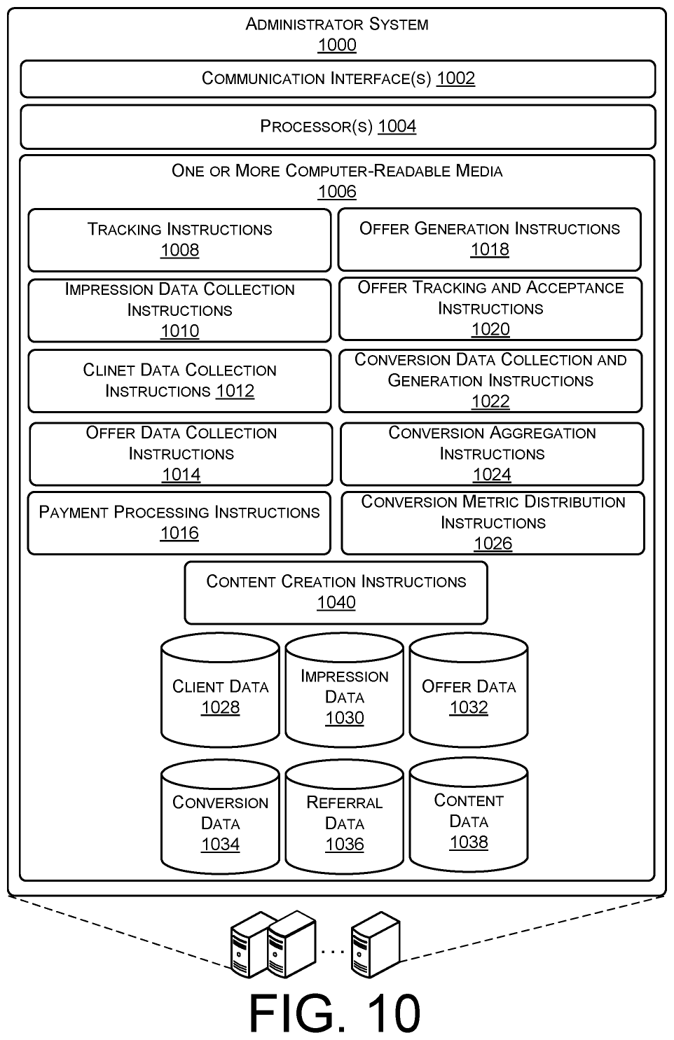

FIG. 10 illustrates example components of one or more servers associated with an administrator system 1000 according to some implementations. For instance, the administrator system 1000 may be a cloud-based system that is hosted by the one or more servers and accessible via one or more networks. The servers, which host the administrator system 1000 may collectively comprise processing resources, as represented by communication interfaces 1002, processors 1004, and computer-readable storage media 1006.

The communication interfaces 1002 may support both wired and wireless connection to various networks, such as cellular networks, radio networks (e.g., radio-frequency identification (RFID)), WiFi networks, short-range or near-field networks (e.g., Bluetooth®), infrared signals, local area networks, wide area networks, the Internet, and so forth. For example, the communication interfaces 0102 may allow the processor 1004 to receive data, such as an impression data from the third-party social media and/or advertising system or offer/client data from the seller system.

The computer-readable storage media 1006 may include volatile and nonvolatile memory, removable and non-removable media implemented in any method or technology for storage of information, such as computer-readable instructions, data structures, program modules, or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computing device.

Several modules such as instruction, data stores, and so forth may be stored within the computer-readable media 1006 and configured to execute on the processors 1004. For example, tracking instructions 1008, impression data collection instructions 1010, client data collection instructions 1012, offer data collection instructions 1014, payment processing instructions 1016, offer generation instructions 1018, offer tracking and acceptance instructions 1020, conversation data collection and generation instructions 1022, conversion aggregation instructions 1024, conversion metric distribution instructions 1026, and/or content creation instructions 1040. The computer-readable media 1006 may also store data usable by the processor 1004 in executing the instructions. For example, the computer-readable media 1006 may store client data 1028, impression data 1030, offer data 1032, conversion data 1034, referral data 1036, and/or content data 1038. The user data 920 may include various information known about each user of the system 900. The position data 922 may related to the various open position with the recruiting system 900, and the referral data 924.

The tracking instructions 1008 may be configured to place and utilize tracking code in order to track user or devices when the access the online hosted content of the seller. For instance, as discussed above with respect to FIG. 5, the tracking instructions 1008 may registers the user and/or the user's device when the device is used to view the online content of the seller (e.g., a website, landing page, or other online content).

The impression data collection instructions 1010 may be configured to receive, request, or otherwise query the third-party social media and/or adverting system and in response to receive the impression data 1030 associated with one or more particular online content.

The client data collection instructions 1012 may be configured to collect or intake client data from the seller. For example, the client data collection instructions 1012 may include a web-based form for a seller to complete via the communication interfaces 1002.

The offer data collection instructions 1014 may be configured to collect or intake offer data from the seller for each individual offer. For example, the offer data collection instructions 1014 may include a web-based form and/or prepopulated templates for a seller to complete via the communication interfaces 1002.

The payment processing instructions 1016 may be configured to allow the new client to provide payment for an offer or project. For example, the payment processing instructions 1016 may be configured to prevent the notification of an acceptance of an offer to the seller system until the payment has been received and processed.

The offer generation instructions 1018 may be configured to generate an offer for a particular client a based on the client data and/or the offer data. In some cases, the offer may include information such as pricing, services and/or goods, scope of work, legal terms, etc.

The offer tracking and acceptance instructions 1020 may be configured to allow the client to execute or otherwise approve of the offer and to prove the approval/acceptance to the seller system. In some cases, the offer tracking and acceptance instructions 1020 may track the execution and counter execution of the offer by both the seller and the new client.

The conversation data collection and generation instructions 1022 may be configured to extract data from the offer, offer data 1032, and the client data 1028 and to combine the extracted data with the impression data 1030 to generate conversion data 1034. For example, the conversion data 1034 may include the number of repeat clients, the frequency of repeat clients, the total number of clients, the average value (e.g., monetary value) of a client, average number of visits or content view prior to acceptance, the average number of counter offers prior to acceptance, ratio of views to acceptances, ratio of clicks to acceptances, average cost per new client, overall value of the advertisement or online content (e.g., revenue minus costs), among others.

In some cases, the conversation data collection and generation instructions 1022 may also utilize referral data 1036 in generating the conversion data 1034. For instance, in these examples, the referral data 1036 may allow the conversation data collection and generation instructions 1022 to include secondary impressions caused by referrals of the online content, referral value of the online content (e.g., monetary value), more accurate reflect the value of the online content by including the referral value, etc.

The conversion aggregation instructions 1024 may be configured to aggregate conversion data 1034 across multiple online advertisements or content. For example, the conversion aggregation instructions 1024 may group similar online advertisements or content and compare performance against the grouped content or as a unit against other online advertisements or content. For example, in constructions and home care, performance of online content related to landscaping may be compared or evaluated with performance of online content related to remolding.

The conversion metric distribution instructions 1026 may be configured to send the conversion data 1034 to the seller system and/or other systems as directed by the seller. For example, the conversion metric distribution instructions 1026 may distribute the conversion data 1034 to the third-party advertising systems, third-party marketing systems, or other systems. The conversion metric distribution instructions 1026 may also make the conversion data 1034 available for access via a cloud-based service.

The content creation instructions 1040 may be configured to generate the opt-in, content pages, content for the landing page or other webpage associated with a seller, and/or the transaction page, among others. For example, the content creation instructions 1040 may receive or access content data 1038 and generate one or more webpages on behalf of the seller based at least in part on the content data 1038. In other cases, the content creation instructions 1040 may generate the content based on data accessible via a network.

Although the subject matter has been described in language specific to structural features, it is to be understood that the subject matter defined in the appended claims is not necessarily limited to the specific features described. Rather, the specific features are disclosed as illustrative forms of implementing the claims.

What is claimed is:

1. A method comprising:
under control of one or more processors configured with executable instructions,
receiving offer data from a seller system associated with a seller;
generating an offer based at least in part on the offer data;
providing access to the offer to a client device;
determining an acceptance of the offer;
generating deal data associated with the offer, the deal data including the monetary value of the offer;
providing the deal data to a third-party system, the third-party system associated with hosting an online content campaign on behalf of a seller.

2. The method as recited in claim 1, further comprising:
receiving client data from a seller system associated with a seller; and
wherein the offer is generated based at least in part on the client data.

3. The method as recited in claim 1, further comprising:
receiving impression data associated with the online content campaign from the third-party system; and
generating conversion data based at least in part on the impression data and the deal data.

4. The method as recited in claim 3, wherein generating the conversion data includes:
detecting a monetary value of the offer from the offer data;
detecting an identifier associated with the client device within the impression data; and
attributing the monetary value to the online content campaign in response to detecting the identifier.

5. The method as recited in claim 3, wherein the conversion data includes:
a sum of the monetary value of the offer and a monetary value of each of a plurality of other offers attributed to the online content campaign;
average length of relationship of clients associated with the online content campaign;
number of clients associated with the online content campaign;
number of clients associated with the online content campaign;
average period of time between first impression of the online content campaign and acceptance of the offer;
total period of time associated with the online content campaign;
number of clients with two or more offers; and
average monetary value of an individual offer associated with the online content campaign.

6. The method as recited in claim 1, wherein the third-party system is a third-party social media platform.

7. The method as recited in claim 1, wherein the third-party system is a third-party advertising system.

8. The method as recited in claim 1, wherein the offer is an offer for services.

9. A method comprising:
under control of one or more processors configured with executable instructions,
receiving offer data from a seller system associated with a seller;
generating an offer based at least in part on the offer data;
providing access to the offer to at least one client device;
determining an acceptance of the offer;
receiving the impression data from a third-party system, the third-party system associated with hosting an online content campaign on behalf of a seller;
generating conversion data associated with the offer, the conversion data including a sum of the monetary value of the offer and a monetary value of each of a plurality of other offers attributed to the online content campaign; and
providing the conversion data to the seller system.

10. The method as recited in claim 9, further comprising providing the conversion data to the third-party system.

11. The method as recited in claim 9, wherein the conversion data also includes:
average length of relationship of clients associated with the online content campaign;
number of clients associated with the online content campaign;
number of clients associated with the online content campaign;
average period of time between first impression of the online content campaign and acceptance of the offer;
total period of time associated with the online content campaign;
number of clients with two or more offers; and
average monetary value of an individual offer associated with the online content campaign.

12. The method as recited in claim 9, wherein generating the conversion data includes:
detecting a monetary value of the offer from the offer data;
detecting an identifier associated with the client device within the impression data; and
attributing the monetary value to the online content campaign in response to detecting the identifier.

13. The method as recited in claim 9, further comprising detecting the identifier associated with a client in response to a display of content hosted by the seller system on a display of one or more of the at least one client device.

14. The method as recited in claim 9, further comprising:
receiving client data from a seller system associated with a seller; and
wherein the offer is generated based at least in part on the client data.

15. An administrator system comprising:
one or more processors; and
a computer-readable media storing instructions, which when executed by the one or more processors, causes the one or more processor to performing actions including:
receiving offer data from a seller system associated with a seller;
generating an offer based at least in part on the offer data;
providing access to the offer to a client device;
determining an acceptance of the offer;
receiving the impression data from a third-party system, the third-party system associated with hosting a first online content campaign on behalf of a seller;
generating conversion data associated with the offer, the conversion data including a sum of the monetary value of the offer and a monetary value of each of a plurality of other offers attributed to the first online content campaign; and
sending the conversion data to the seller system.

16. The administrator system as recited in claim 15, wherein the conversion data also includes at least one of:
average length of relationship of clients associated with the first online content campaign;
number of clients associated with the first online content campaign;
number of clients associated with the first online content campaign;
average period of time between first impression of the first online content campaign and acceptance of the offer;
total period of time associated with the first online content campaign;
number of clients with two or more offers; or
average monetary value of an individual offer associated with the first online content campaign.

17. The method as recited in claim 15, wherein the computer-readable media stores additional instructions, which when executed by the one or more processors, cause the one or more processors to perform actions including:
receiving client data from a seller system associated with a seller; and
wherein the offer is generated based at least in part on the client data.

18. The method as recited in claim 15, wherein generating conversion data is in response to determining a threshold has been meet or exceeded.

19. The method as recited in claim 15, wherein the computer-readable media stores additional instructions, which when executed by the one or more processors, cause the one or more processors to perform actions including:
generating aggregated conversion data based at least in part on a comparison of the conversion data and second conversion data, the second conversion data associated with a second online content campaign.

20. The method as recited in claim 19, wherein good or services of the second online content campaign are related to good or services of the first online content campaign.
